(19) United States
(12) Patent Application Publication
(10) Pub. No.: US 2006/0116613 A1
(43) Pub. Date: Jun. 1, 2006

(54) Mechanisms for generating improved hemodynamics during CPR

(75) Inventors: Henry R. Halperin, Sunnyvale, CA (US); James Adam Palazzolo, Sunnyvale, CA (US); Bob H. Katz, Sunnyvale, CA (US)

Correspondence Address: CROCKETT & CROCKETT, 24012 CALLE DE LA PLATA, SUITE 400, LAGUNA HILLS, CA, 92653, US

(73) Assignee: Revivant Corporation

(21) Appl. No.: 11/000,136

(22) Filed: Nov. 29, 2004

(51) Int. Cl. A61H 31/00

(52) U.S. Cl. 601/41

(57) ABSTRACT

Devices and methods for substantially closing the airway of a patient during cardiopulmonary resuscitation. A chest compression device designed to compress substantially the entire chest of a patient is used to perform chest compression on the patient. As the chest of the patient is compressed, the airway of the patient is substantially closed, thereby preventing the flow of gasses through the airway. Because gasses cannot flow through the airway of the patient, intrathoracic pressure increases during chest compressions relative to manual chest compressions or other point chest compressions.

### FIELD OF THE INVENTIONS

The inventions described below relate the field of cardiopulmonary resuscitation.

### BACKGROUND OF THE INVENTIONS

Patients suffering from cardiac arrest or ventricular fibrillation are often treated with cardiopulmonary resuscitation (CPR), which involves the application of closed chest compressions and ventilation. Chest compressions cause blood to flow within the patient by a combination of directly squeezing the heart and by increasing intrathoracic pressure within the patient. Chest compression techniques that create high intrathoracic pressure have been shown to create higher blood pressure, blood flows, and higher survival rates relative to manual CPR. Research has shown that an increase in intrathoracic pressure can be achieved mechanically by obstructing the patient's airway during CPR. Obstructing the patient's airway causes gasses to remain in the patient's lungs during a compression thereby increasing intrathoracic pressure. Current techniques for closing a patient's airway during CPR disclose using an external airway such an endotracheal tube or other ventilation tubing coupled with a valve. An exit valve in use with an endotracheal tube is configured to prevent respiratory gases from exiting a person's lungs when the exit valve is closed. This valve can be actuated in phase with chest compression to resist flow during CPR.

Mechanically obstructing the airway to retard air flow during the compression phase of CPR has many disadvantages. One method for retarding airflow requires an endotracheal tube to be inserted into a patient in order to close a patient's airway during compressions. Inserting an endotracheal tube can delay the start of compressions during CPR and result in a lower survival rate or neurological damage to the patient. In addition, inserting an endotracheal tube into a patient subjects the patient to a variety of additional hazards. These hazards include inadvertent intubation of the esophagus, upper airway trauma (laryngeal or esophageal damage), cervical spine trauma, facial trauma, and dental trauma. Another method for mechanically obstructing the airway to retard airflow during the compression phase of CPR requires the use of a face mask having an impedance valve. This method also poses additional risks to the patient. The use of the face mask has the potential to force air into the gastrointestinal system (gastric insufflation) during CPR.

Improved methods and devices are needed to close a patients' airway during chest compressions without the need of additional equipment. The method and device disclosed in this application cause an increased in airway resistance or air trapping without the need for an external valve, actuator or control system.

### SUMMARY

The methods and devices described below provide for a means of impeding airflow in a patient during chest compressions. A chest compression device designed to compress substantially the entire chest of a patient is used to perform chest compression on the patient applying sufficient force to substantially restrict or throttle airflow in the patient's airway. Because gasses cannot flow through the airway of the patient, intrathoracic pressure increases during chest compressions (relative to manual chest compressions or chest compressions performed with other kinds of automated chest compression devices). The increase in intrathoracic pressure in the patient during chest compressions increases cerebral, coronary, and pulmonary blood flow in the patient.

### BRIEF DESCRIPTION OF THE DRAWINGS

FIG. 1 illustrates a patient with a chest compression device fitted on the patient and ready for use.

FIG. 2 shows a patient and the airway of a patient.

FIG. 3 shows a cross section of a patient before a chest compression using a chest compression device for generating improved hemodynamics during CPR.

FIG. 4 shows a cross section of a patient during a chest compression using a chest compression device for generating improved hemodynamics during CPR.

### DETAILED DESCRIPTION OF THE INVENTIONS

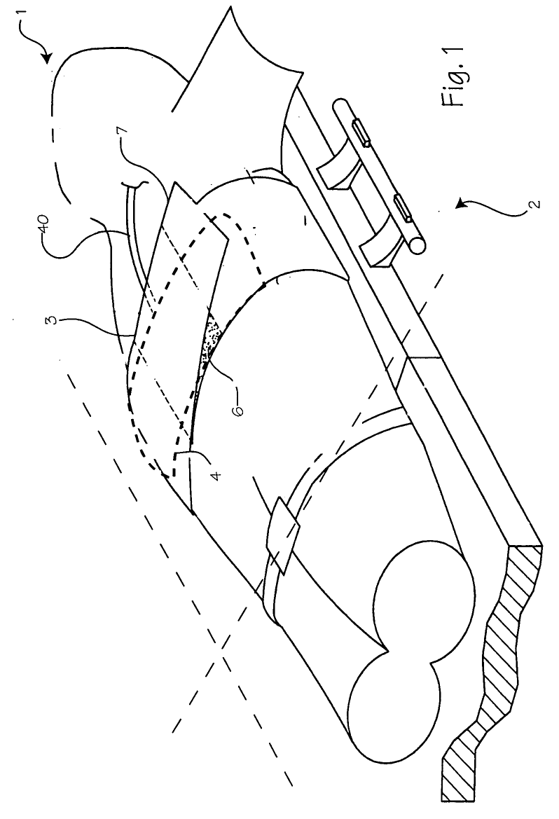

FIG. 1 illustrates a patient 1 with a chest compression device 2 fitted on the patient 1 and ready for use. A belt 3 and a belt tightening mechanism within the backboard comprise the means for compressing the chest of the patient. Preferably, a pad or bladder 4 is disposed between the patient's chest and the compression belt 3. Alternatively, a pad or bladder 4 may be attached to the belt 3 and disposed directly over the chest of the patient. The belt 3 is secured around the body with a fastener. The fastener may comprise two overlapping areas 6 and 7 of a hook and loop fastener such as Velcro®. Preferably, the bladder 4 or belt 3 is sized and dimensioned to cover substantially the entire chest of the patient 1 in manner where the belt 3 or bladder 4 covers the entire sternum 40. Force from the belt 3 or bladder 4 spread over the substantially the entire chest will cause the airway of the patient to substantially collapse 1. In addition, the chest compression device 2 compresses and decompresses the chest more rapidly relative to manual chest compressions and is operated to provide rapid compression stroke sufficient to ensure airway collapse.

By appropriately sizing the belt 3 or bladder 4, applying sufficient compressive force through the belt, and compressing the chest in a sufficiently rapid manner, compressions performed by the device 2 during CPR will cause the airway of the patient 1 to substantially collapse during the compression phase of CPR. A substantially collapsed airway restricts the flow of gasses through the airway during a chest compression. With gasses trapped in the patient's lungs and airway, intrathoracic pressure increases during a chest compression relative to other chest compression techniques that do not close the airway of the patient. In turn, blood flow provided by compressions using the device shown in FIG. 1 is improved over other chest compression techniques, including use of the device at lower force levels.

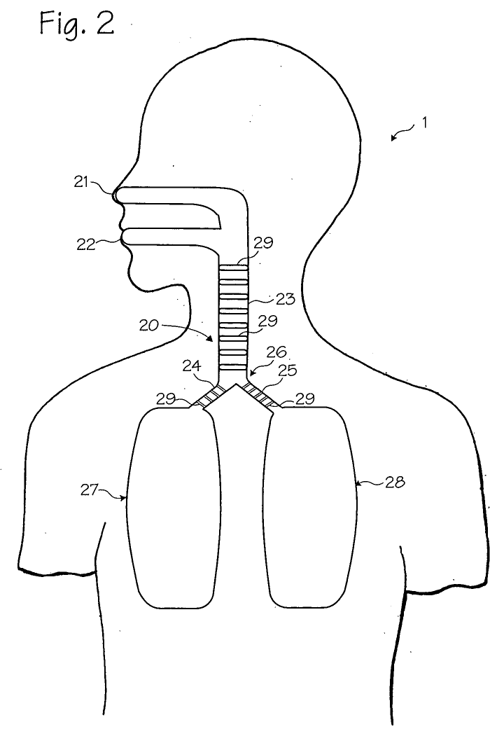

FIG. 2 shows a patient 1 and the airway or respiratory tract 20 of a patient. Under normal conditions, air enters the respiratory tract through the nose 21 or mouth 22 and is transmitted through the trachea 23 to a bifurcation into the right bronchus 24 and left bronchus 25 known as the carina 26. The right and left bronchi communicate with the right lung 27 and left lung 28, respectively. The airway of the lungs branches for 20 to 25 generations until the alveoli are reached (where gas exchange between the blood and air takes place). To keep the respiratory tract from collapsing during normal respiration, regularly spaced cartilage rings 29 extend nearly around the trachea. The size and dimensions of the rings 29 steadily decreases in size with each branching of the respiratory tract until the smallest areas of the respiratory tract are prevented from collapsing by trans-pulmonary pressure gradients instead of by cartilage rings 29.

The cartilage rings 29 cause the respiratory tract 20 to resist collapse. During manual chest compressions, point chest compressions or chest compressions performed by most techniques, the airway 20 does not collapse because there is no force component effectuated on the airway. Accordingly, air escapes from the lungs during a chest compression resulting in a lower than desired intrathoracic pressure.

The airway 20 may be collapsed, despite the relative rigidity of the airway 20, by compressing the chest of the patient 1 with a device sized and dimensioned to cover substantially the entire chest of the patient. Such a device is shown in FIG. 1. Studies performed with a belt-driven chest compression device similar to that shown in FIG. 1 have demonstrated airway collapse not occurring in manual CPR or other chest compression techniques.

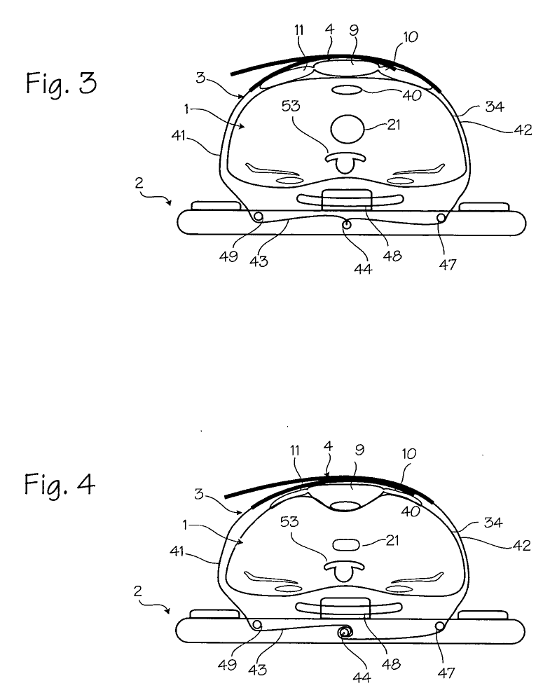

FIGS. 3 and 4 show the effect of a chest compression by the chest compression device shown in FIG. 1 on the airway 20 of a patient 1. Using a device shown in FIG. 1, respiratory collapse during the compression phase of CPR generally begins mid-trachea and extends past the carina and into the left and right bronchi for several generations (down to bronchi of diameter 1.5 mm or less). The substantial collapse of a substantial portion of the patient's airway 20 prevents air from escaping the airway 20.

FIG. 3 is a cross section of a patient 1 prior to compression in an automatic chest compression device 2 with the bladder 4 disposed over the sternum 40 of the patient 1, between the chest of the patient and the belt 3. The bladder 4, having a central section 9, a right lateral section 10, and left lateral section 11, is disposed over the patient's sternum 40. The airway 20 is not collapsed prior to compression. The bladder 4 helps apply force preferentially to the sternum 40 while ensuring that other areas of the thorax 34 receive an even distribution of force during compressions. The belt left section 41 and right sections 42 are joined in a seam to pull straps 43. The pull straps 43 are fixed to the drive spool 44. The belt right section 42 extends with the pull strap 43, around the upper right spindle 47, under a spinal support platform 48 and to the drive spool 44 when in use. The belt left section 42 extends with the pull strap around the upper left spindle 49, under the spinal support platform 48 and to the drive spool 44 when in use. The spine 53 is shown for reference.

FIG. 4 is a cross section of a patient 1 disposed in an automatic chest compression device 2 during a compression. During compressions the thorax 34 is maintained in a somewhat oval cross section. However, since the lateral portions of the thorax 34 are less compressible than the sternum, the force of compressions forces fluid pressure from the left lateral section 11 and right lateral section 10 to the center section during compressions. In response, the center section 9 deforms preferentially, causing substantial collapse of a substantial portion of the patient's airway 20 preventing air from escaping the airway.

As seen in FIGS. 3 and 4, the bladder has a first relaxed configuration which it assumes when the belt 3 is loosened about the chest, as in FIG. 3, and a second pressurized configuration which it assumes when the belt is constricted about the chest of the patient 1, as in FIG. 4. In the relaxed configuration, the right lateral section 10, center section 9 and left lateral section 11 are each filled with fluid. In the pressurized configuration, the right lateral section 10 and left lateral section 11 are substantially compressed and some or all of the fluid therein is forced into the center section. (The bladder is substantially fluid-tight, and does not permit substantial flow of fluid into and out of the bladder during compressions.) The relative sizes of the bladder sections may be adjusted (by appropriate location of the seams that join the upper and lower sheets) to provide chambers of appropriate relative size so that the lateral chambers are not fully compressed and emptied of fluid when compressed with the forces expected during compressions, and the anterior-posterior bulging of the central section is limited.

Experiments evaluating airway collapse of a patient have shown the location of the collapse region is not as important as the fact that the collapse occurred somewhere within the airway 20. Respiratory collapse using the device shown in FIG. 1 generally began mid-trachea and extended past the carina and into the left and right bronchi for several generations (down to bronchi of diameter 1.5 mm or less). A reduction in the cross section of the airway by as little as 40% is effective at substantially impeding airflow through the airway and raising intrathoracic pressure. A reduction greater than 40% in the cross section of the airway 20 as shown in FIG. 4 may be achieved using the device of FIG. 1

Another benefit of using a wide belt or bladder when performing chest compressions is additional artificial ventilation may not be necessary when a wide belt or bladder is used to compress the patient. Chest compressions with a wide belt or bladder cause overpressure within the airway of the patient. During decompression of the chest, the airway opens. The overpressure causes air to be forced from the patient's airway until there is a slight under pressure within the airway. As the decompression phase is completed, some air flows back into the patient's airway, thereby providing fresh oxygen to the patient. Thus, if additional artificial respiration is not available, it is possible to revive a patient successfully using only chest compressions applied with a wide belt or a wide bladder if those compressions are forceful enough to collapse the airway. (In addition, the cyclical obstruction and opening of the respiratory tract in phase with chest compressions did allow normal gas exchange and additional ventilation.)

Referring again to FIG. 1, the belt is operably connected to the belt tightening mechanism, which provides the force necessary to tighten the belt about the patient's chest and thorax. The belt tightening mechanism may be a motor and motor driven spool as shown in our application Ser. Nos. 09/866,377, 10/686,549 or Ser. No. 10/686,188 incorporated here by reference. It may also be other mechanisms for tightening the belt such as a pull-lever or other manual devices for tightening the belt. The belt and bladder may be a configuration as shown in our application Ser. Nos. 10/192,771, 10/686,185, 10/686,186 and 10/686,184 incorporated herein by reference.

The central section of the bladder 9 is disposed over the sternum 40 of the patient 1. The right lateral section 10, separated from the central section 9 by a vertical divider, is disposed over the right lateral portion of the patient's chest and the left lateral section 11, separated from the central section by a vertical divider, is disposed over the left lateral portion of the patient's chest. The left 11 and right 10 lateral sections of the bladder extend along the medial-lateral direction over the patient's rib cage. Depending on the length of the bladder, the left lateral and right lateral sections may completely cover the patient's rib cage. For most patients, however, the bladder covers the anterior surface of the chest from armpit to armpit and along the superior-inferior length of the sternum. Thus, the entire bladder 4 may be about 6 to 8 inches high, about 12 to 16 inches wide, and about 1.5 inches thick. When provided in this size range, the bladder will cover substantially the entire chest of a typical patient. Specifically, a rectangular bladder of about 8 inches high by about 16 inches wide (again, relative to the patient) by about 1.5 inches thick is suitable to fit most patients, and may be provided for use on all patients.

The bladder 4 is filled with a pressure-transmitting medium, such as a gas or liquid. The bladder may also be filled with foam, such as an open-cell foam or a filter foam, that allows air to flow throughout the bladder. The foam provides the bladder with structural support such that the bladder does not collapse if the bladder is not filled with a pressure-transmitting medium. In addition, the bladder 4 may be provided with a valve that allows a user to either increase or decrease the pressure inside the bladder.

In all patients, the bladder 4 alters the pressure on the patient's chest during compressions, creating a uniform field of pressure over the entire chest. The uniform pressure field has the effect of first compressing the chest in the most compliant regions of the chest. (Hence, in most patients the peri-sternal region is compressed first). In turn, the next most compliant part of the chest will be compressed somewhat more than the next least compliant portion. Ultimately, the entire chest is compressed to at least some extent, with the most compliant regions of the chest being compressed more than the least compliant regions of the chest. Thus, during chest compressions, the pressure field maximizes the reduction in thoracic volume for a given force applied to the chest. We have observed the presence of the bladder creates more effective blood circulation during chest compressions.

In addition, the bladder 4 allows the chest compression device to apply more total force to the patient 1 while also decreasing the probability of hurting the patient, since the force per unit area on the chest is altered by the presence of the bladder 4. A bladder 4 allows the total force applied to the chest to be about 100 pounds to about 700 pounds. We preferably apply about 350 to 400 pounds of total force to the chest with the chest compression belt 3 illustrated in FIG. 1. Thus, the bladder 4 allows a chest compression device 2 to far exceed previously known total force limits during chest compressions while maintaining or decreasing the probability, as compared to manual compressions or device-driven compressions without a bladder, of injuring the patient. Conversely, because the bladder 4 may have a bottom surface area of about 100 square inches, the force density (the per square inch force applied) may be well below typical manual CPR levels, and effective CPR compressions can be provided with forces of less than 10 psi applied on the chest. We preferably apply about 2.50 to 4 pounds per square inch to chest with the chest compression belt illustrated in the FIG. 1.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A method of substantially preventing gasses from flowing through an airway of a patient during chest compressions, said method comprising the steps of:
providing a chest compression device comprising:
a belt; and
a belt tightening mechanism;
operably connecting the chest compression device to the patient;
compressing the chest of the patient repetitively with the chest compression device;
using force sufficient to effect cardiopulmonary resuscitation while causing the airway of the patient to close at least partially during the compression phase of cardiopulmonary resuscitation; and
allowing the chest to expand and the airway to expand between compressions.

2. A device for compressing the chest of a patient, said device comprising:
a belt;
a belt tightening mechanism; and
a control system programmed to:
cause the belt tightening mechanism to compresses the chest of the patient repetitively to effect CPR;
apply force to a sufficient degree causing the airway of the patient to close at least partially when the belt compresses the chest; and
allow the chest and the airway to expand between compressions.
